(19) United States
(12) Patent Application Publication
(10) Pub. No.: US 2018/0087501 A1
(43) Pub. Date: Mar. 29, 2018

(54) ROTARY VALVE UTILIZING LOW SHEAR EXCHANGEABLE BORE

(71) Applicant: Ryan R. Hopkins, Reno, NV (US)

(72) Inventor: Ryan R. Hopkins, Reno, NV (US)

(73) Assignee: Moldman Systems LLC, Reno, NV (US)

(21) Appl. No.: 15/280,743

(22) Filed: Sep. 29, 2016

(51) Int. Cl. F04B 53/10; F16K 11/085; F16K 27/06; F16K 5/04; F04B 19/22; F04B 49/22

(52) U.S. Cl. CPC F04B 53/10; F16K 11/0853; F16K 27/065; F04B 49/22; F16K 5/0478; F04B 19/22; F16K 5/045

(57) ABSTRACT

A valve assembly including a valve body, a sleeve member and a valve member is provided. A low shear sleeve member is positioned within an internal cavity of the valve body. The valve member is slidably carried within an internal cavity of the sleeve member. The valve member includes a first flow passage formed within the valve member and a first shut-off region. The valve member is moveable between a first position in which fluid flow from a first sleeve member inlet port to a first sleeve member outlet port is prohibited and a second position in which fluid flow from the first sleeve member inlet port to the first sleeve member outlet port is permitted. Delivery systems incorporating the valve assembly are also provided.

### FIELD OF THE INVENTION

This invention generally relates to valves for processing shear sensitive materials and particularly highly filled shear sensitive materials.

### BACKGROUND OF THE INVENTION

Highly filled shear sensitive materials need to be processed in low shear environments to ensure that the materials are not exposed to high energy environments. High energy environments can cause shear sensitive materials to thicken, gel or even cure. As such, it is desirable to process these types of materials with equipment that have low shear interfaces between components of the processing equipment that move relative to one another.

The present invention provides improvements over the current state of the art related to material delivery systems and particularly valves for material delivery systems for delivering shear sensitive materials and more particularly highly filled shear sensitive materials.

### BRIEF SUMMARY OF THE INVENTION

Embodiments of the invention relate to new and improved devices for processing materials with low shear. More particularly, a new and improved delivery mechanism is provided. Even more particularly, a new and improved valve assembly for a delivery mechanism is provided.

In one embodiment, a valve assembly including a valve body, a sleeve member and a valve member is provided. The valve body defines a valve body internal cavity, a first valve body inlet port in communication with the internal cavity and a first valve body outlet port in fluid communication with the valve body internal cavity. The low shear sleeve member is positioned within the internal cavity. The sleeve member defines a sleeve member internal cavity, a first sleeve member inlet port in fluid communication with the sleeve member internal cavity and a first sleeve member outlet port in fluid communication with the sleeve member internal cavity. The first sleeve member inlet port is in fluid communication with the first valve body inlet port. The first sleeve member outlet port is in fluid communication with the first valve body outlet port. The valve member is slidably carried within the sleeve member internal cavity. The valve member includes a first flow passage formed within the valve member and a first shut-off region. The valve member is moveable between a first position in which fluid flow from the first sleeve member inlet port to the first sleeve member outlet port is prohibited and a second position in which fluid flow from the first sleeve member inlet port to the first sleeve member outlet port is permitted.

In one embodiment, an inner surface of the sleeve member defining the sleeve member internal cavity and an outer surface of the valve member define a sliding interface. The frictional coefficient between the inner surface and the outer surface is greater than 0 and less than or equal to 0.5.

In one embodiment, the valve member is rotatably carried within the sleeve member.

In one embodiment, the sleeve member is replaceable.

In one embodiment, the valve member is formed from metal, the valve body is formed from metal and the sleeve member is formed from a low friction non-metal.

In one embodiment, the low friction non-metal is an ultra-high molecular weight polyethylene.

In one embodiment, the sleeve member is fixed relative to the valve body to prevent motion of the sleeve member when the valve member moves between the first and second positions.

In one embodiment, the valve member carries a first seal member that surrounds the first shut-off region and seals on an inner surface of the sleeve member and around the first sleeve member inlet port when the valve member is in the first position.

In one embodiment, the valve assembly further includes a second seal member that seals the first valve body inlet port to the first sleeve member inlet port.

In one embodiment, an interface between the sleeve member and the valve body at the first sleeve member and first valve body outlet ports is free of a seal member therebetween and interfaces between the sleeve member and the valve member in both the first and second positions is free of a seal member therebetween.

In one embodiment, the valve body defines a second valve body inlet port in communication with the internal cavity and a second valve body outlet port in fluid communication with the valve body internal cavity. The low shear sleeve defines a second sleeve member inlet port in fluid communication with the sleeve member internal cavity and a second sleeve member outlet port in fluid communication with the sleeve member internal cavity. The second sleeve member inlet port is in fluid communication with the second valve body inlet port. The second sleeve member outlet port is in fluid communication with the second valve body outlet port. The valve member defines a second flow passage formed within the valve member and a second shut-off region formed by the valve member. When the valve member is in the second position, fluid flow from the second sleeve member inlet port to the second sleeve member outlet port is prohibited. When the valve member is in the first position, fluid flow from the second sleeve member inlet port to the second sleeve member outlet port is permitted.

In one embodiment, the first and second valve body inlet ports are on opposite sides of the valve member as one another and the first and second valve body outlet ports are on opposite sides of the valve member as one another. The first valve body inlet port is on the same side of the valve member as the second valve body outlet port.

In one embodiment, the valve member is operably coupled to an actuator for driving the valve member between the first and second positions.

In another embodiment, a material delivery system including a valve assembly as described above, a pumping body and a pumping piston is provided. The pumping body has a pumping body pumping cavity in fluid communication with the first valve body outlet and the second valve body inlet. The pumping piston is carried in the pumping body pumping cavity and is configured to increase and decrease the volume within the pumping body pumping cavity. Fluid is permitted to flow into the pumping body pumping cavity through the first valve body outlet when the valve member is in the second position and permitted to flow out of the pumping body pumping cavity through the second valve body inlet when the valve member is in the first position.

In one embodiment, the valve member is operably coupled to an actuator for driving the valve member between the first and second positions. The pumping piston is operably coupled to an actuator for driving the pumping piston.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an embodiment of a delivery system according to an embodiment;

FIG. 2 is a partial cross-section of the delivery system of FIG. 1;

FIG. 3 is a perspective illustration of a valve assembly used in the delivery system of FIG. 1;

FIGS. 4 and 5 are partial cross-sectional illustrations of the valve assembly of FIG. 3;

FIG. 6 is a partial exploded illustration of the valve assembly of the delivery system;

FIGS. 7 and 8 are perspective illustrations of the sleeve member and valve member of the valve assembly of the delivery system;

FIG. 9 is a perspective illustration of an alternative embodiment of a sleeve member and valve member for use in the valve assembly of the delivery system;

FIG. 10 is a partial exploded illustration of the valve assembly using the sleeve member and valve member of FIG. 9;

FIG. 11 is a perspective illustration of an alternative valve member; and

FIG. 12 is a perspective illustration of an alternative embodiment of a sleeve member and valve member for use in a valve assembly of a delivery system using the valve member of FIG. 11.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

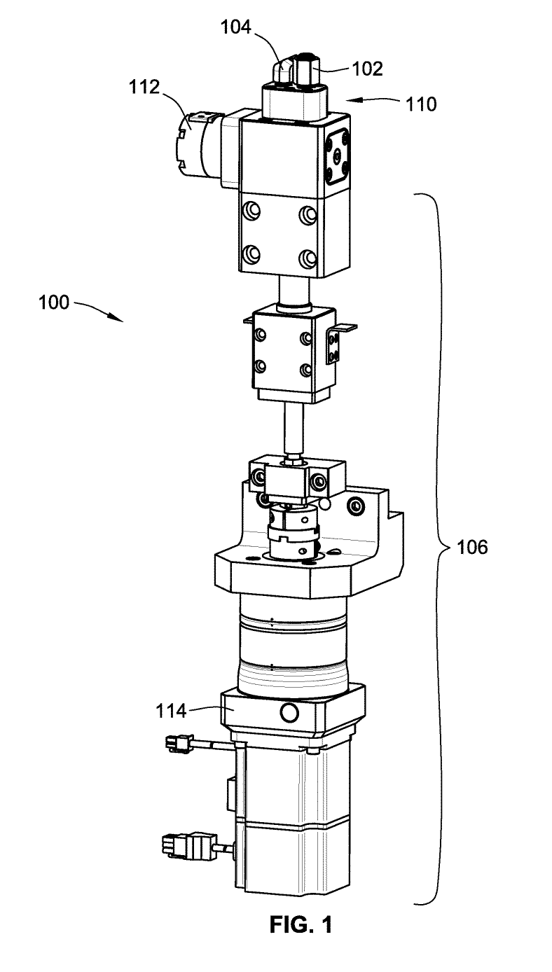

FIG. 1 illustrates a material delivery system 100 (referred to herein as “delivery system 100”) for delivering material and particularly highly filled shear sensitive, highly viscous, materials, such as for molding operations. The delivery system 100 has an inlet port 102 and an outlet port 104. The inlet port 102 is to be coupled to a source of material (not shown) and the outlet port 104 is to be coupled to a downstream system that uses the material.

The delivery system 100 receives the material and then uses a pump assembly 106 to selectively dispense the material out of outlet port 104.

A valve assembly 110 operably controls the flow of fluid into the pump assembly 106 from inlet port 102 as well as out of outlet port 104. The valve assembly 110 also prevents fluid from backflowing back into the inlet port 102 when fluid is pumped through outlet port 104.

The valve assembly 110 and pump assembly 106 each include motors 112, 113 for selectively controlling the components.

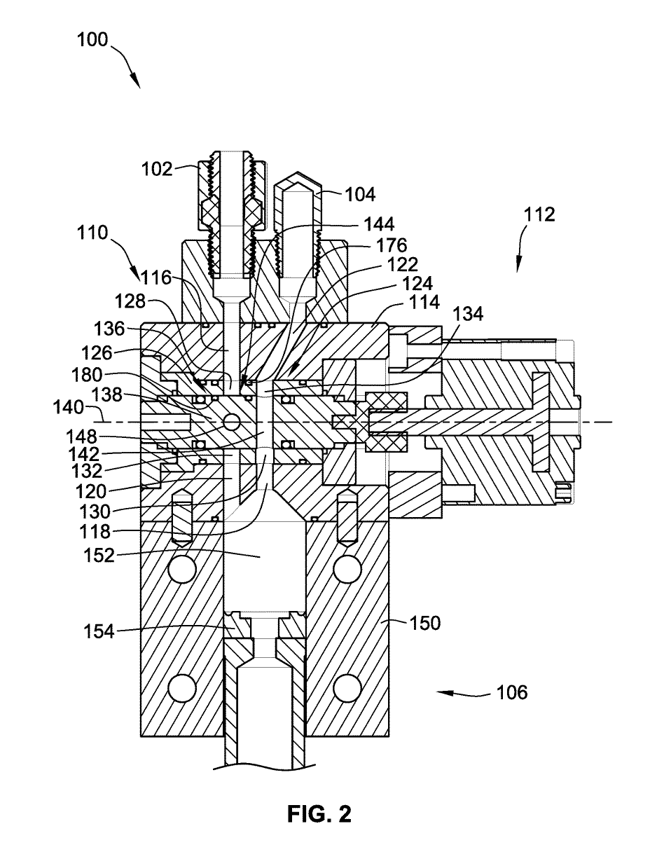

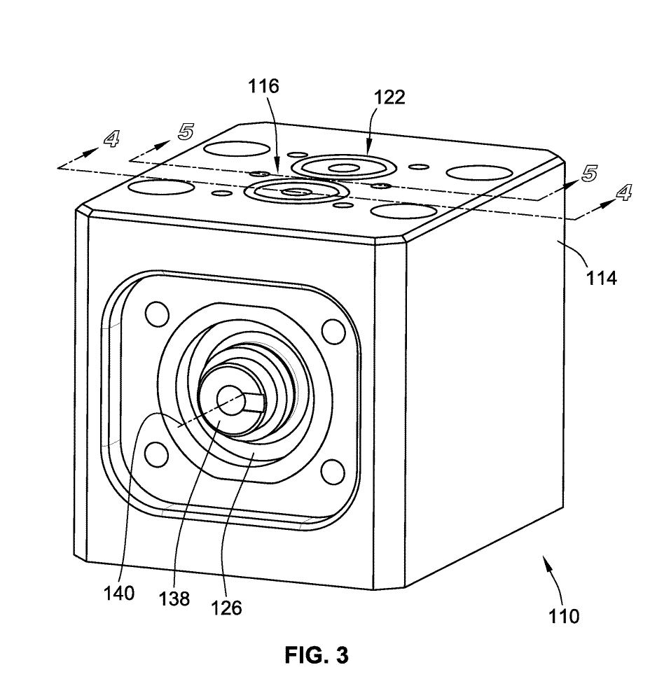

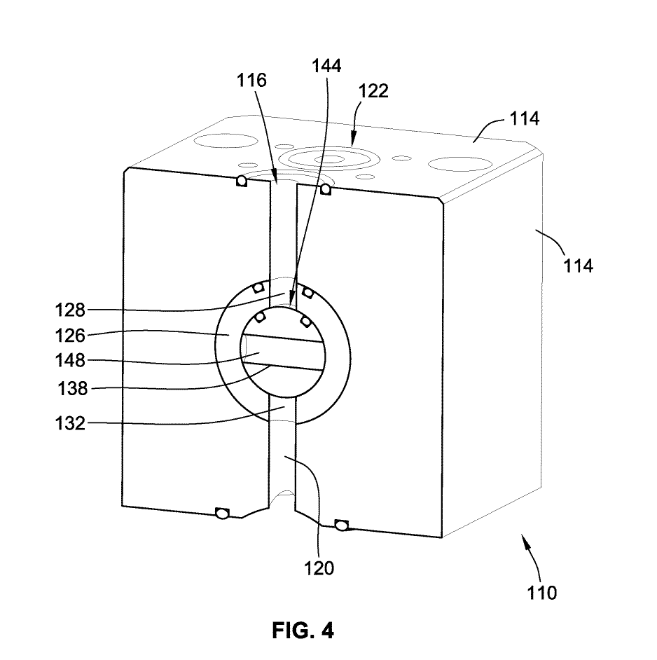

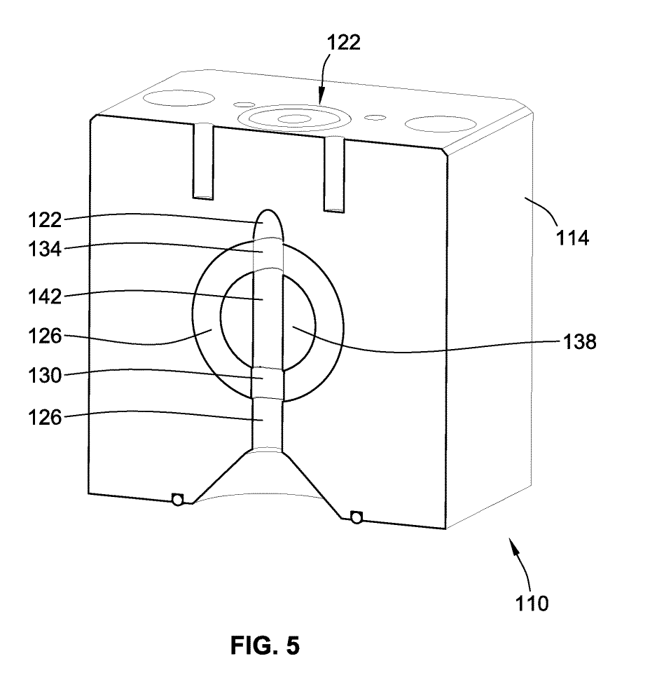

FIG. 2 illustrates a portion of the delivery system 100 in cross-section including the valve assembly 110 and a portion of the pump assembly 106. FIGS. 3-6 provide additional illustrations of the valve assembly 110 in cross-section and in exploded format.

The valve assembly 110 includes a valve body 114 that defines first and second valve body inlet ports 116, 118 and first and second valve body outlet ports 120, 122. The valve body inlet and outlet ports 116, 118, 120, 122 are in fluid communication with a valve body internal cavity 124.

A low shear sleeve member 126 (referred to herein as “sleeve member 126”) is located within the valve body internal cavity 124. The sleeve member 126 includes first and second sleeve member inlet ports 128, 130 and first and second sleeve member outlet ports 132, 134 that communicate with a sleeve member internal cavity 136. The first and second sleeve member inlet ports 128, 130 fluidly communicate with the first and second valve body inlet ports 116, 118, respectively. The first and second sleeve member outlet ports 132, 134 fluidly communicate with the first and second valve body outlet ports 120, 122, respectively.

A valve member 138 is slidably carried within the sleeve member internal cavity 136. In this embodiment, the sliding action is rotational motion angularly about axis 140. The inner surface of the sleeve member defining internal cavity 136 and the outer surface of valve member 138 provide a sliding interface. The valve member 138 in this embodiment is rotatable between a first position that prevents fluid flow from the first sleeve member inlet port 128 to the first sleeve member outlet port 132 but permits fluid flow from the second sleeve member inlet port 130 to the second sleeve member outlet port 134. More particularly, in this position a first flow passage 142 that extends transversely to axis 140 through the valve member 138 fluidly connects the second sleeve member inlet port 130 to the second sleeve member outlet port 134.

In this embodiment, the first sleeve member inlet port 128 and first sleeve member outlet port 132 are on opposite sides of the valve member 138. The second sleeve member inlet port 130 and second sleeve member outlet port 134 are on opposite sides of the valve member 138. The first sleeve member inlet port 128 and second sleeve member outlet port 134 are on the same side of the valve member 138. The second sleeve member inlet port 130 and first sleeve member outlet port 132 are on the same side of the valve member 138.

The valve member 138 includes a first shut-off region 144 that aligns with the first sleeve member inlet port 128 and first sleeve member outlet port 132 to prevent fluid flow therebetween.

In a second position, the valve member 138 is rotated 90 degrees and the first sleeve member inlet port 128 is fluidly connected to the first sleeve member outlet port 132 via second flow passage 148. Additionally, in this position, a second shut-off region (not shown in FIG. 2) prevents fluid flow from the second sleeve member inlet port 130 to the second sleeve member outlet port 134.

The valve member 138 is operably coupled to motor 112 to selectively rotate the valve member between the first and second positions.

The valve assembly 110 is operably coupled to pump assembly 106. The pump assembly 106 includes a pumping body 150 that defines a pumping cavity 152 that is in fluid communication with the first valve body outlet port 120 and the second valve body inlet port 118. A pumping piston 154 is carried within the pumping cavity 152 to selectively change the volume of the pumping cavity 152 to allow material to flow into the pumping cavity 152 and then be pumped out of the pumping cavity 152 by axial motion of the piston 154 towards the valve body 114. An actuator, such as motor 113 can operably drive the pumping piston 154.

When the valve member 138 is in the second position, fluid is allowed to flow from inlet port 102 through the valve assembly 110 and into pumping cavity 152. When material is to be delivered, valve member 138 is rotated to the first position. Thereafter, the piston 154 is actuated and material is pushed out of the pumping cavity 152 through the valve assembly 110 and out outlet port 104.

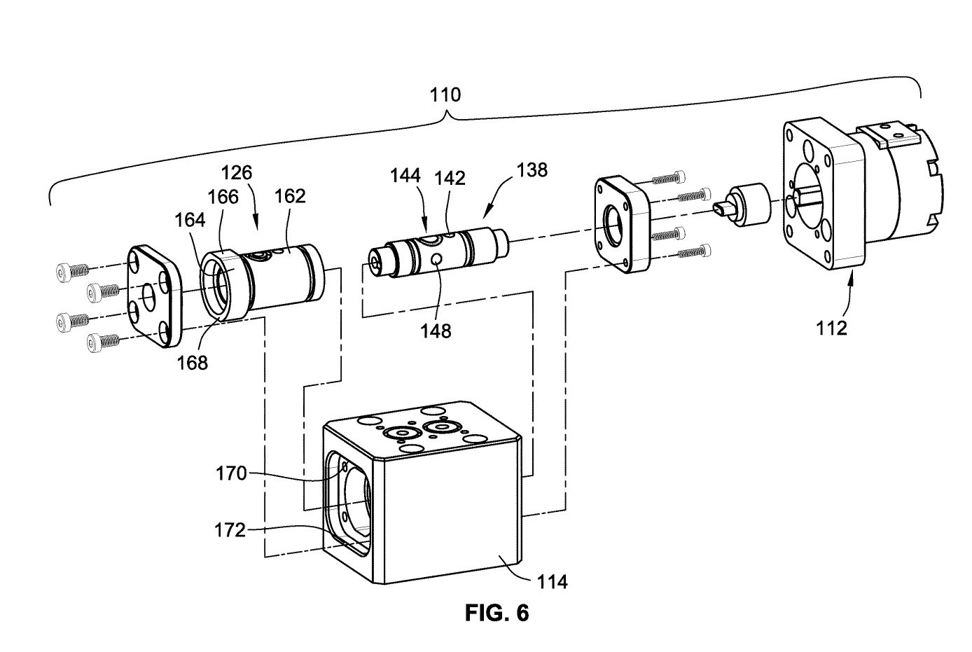

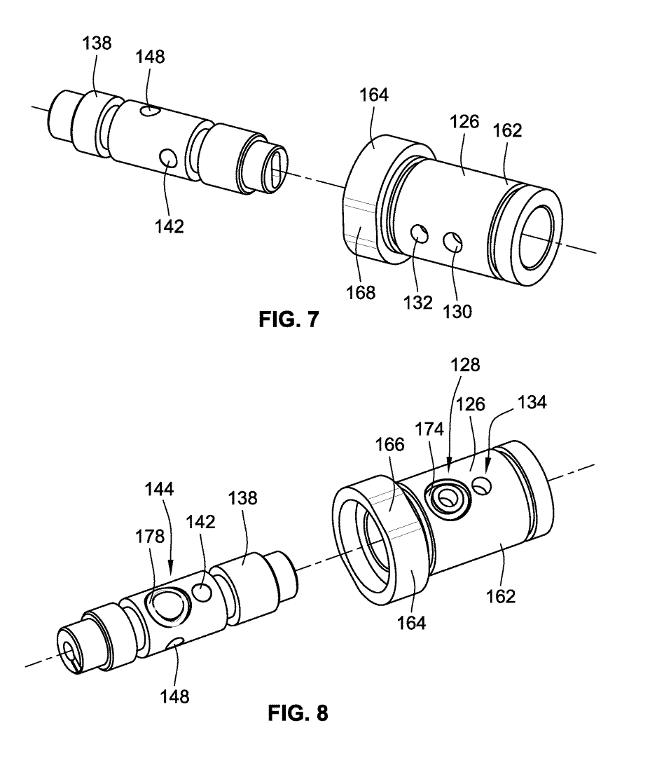

With reference to FIGS. 6-8, the sleeve member 126 includes a generally cylindrical body 162 that includes a flared end 164. The flared end 164 has a pair of flats 166, 168 that cooperate with flats 170, 172 of valve body 114 to prevent rotation of the sleeve member 126 within the valve body 114.

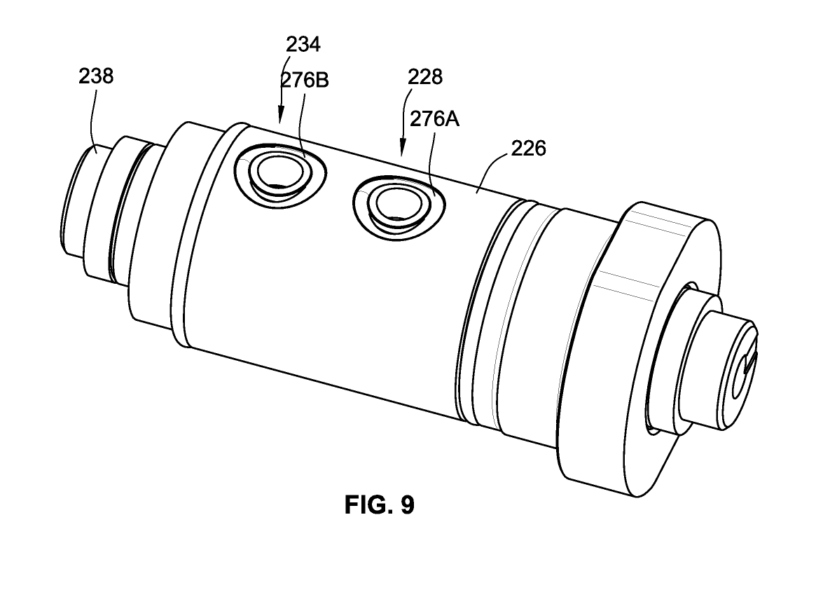

With additional reference to FIGS. 2 and 8, the sleeve member 126 includes a generally circular groove 174 that surrounds the first sleeve member inlet port 128. This groove 174 holds a seal member in the form of an o-ring 176 (see FIG. 2). This seal member improves the sealing interface between the first valve body inlet port 116 and the first sleeve member inlet port 128 and prevent reverse flow of material back into inlet port 102 and back to the source of material.

Similarly, valve member 128 includes a circular groove 178 that surrounds first shut-off region 144 for holding seal member 180 (see FIG. 2). This seal member 180 improves the sealing interface between the valve member 138 and the sleeve member 126 when the valve member is in the first position. This also prevents the reverse flow of material back into the inlet port 102 when material is being dispensed using piston 154.

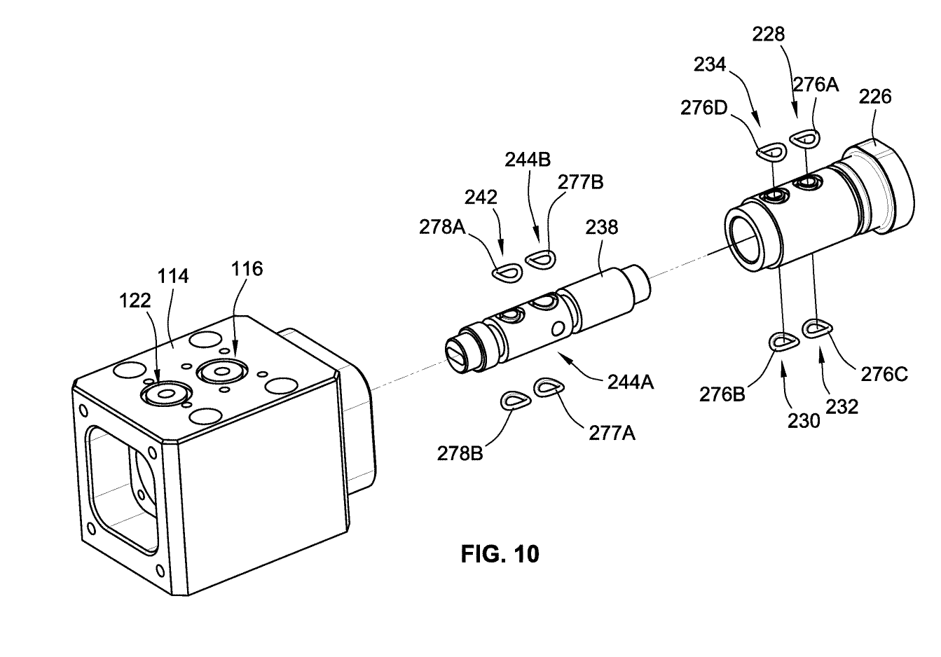

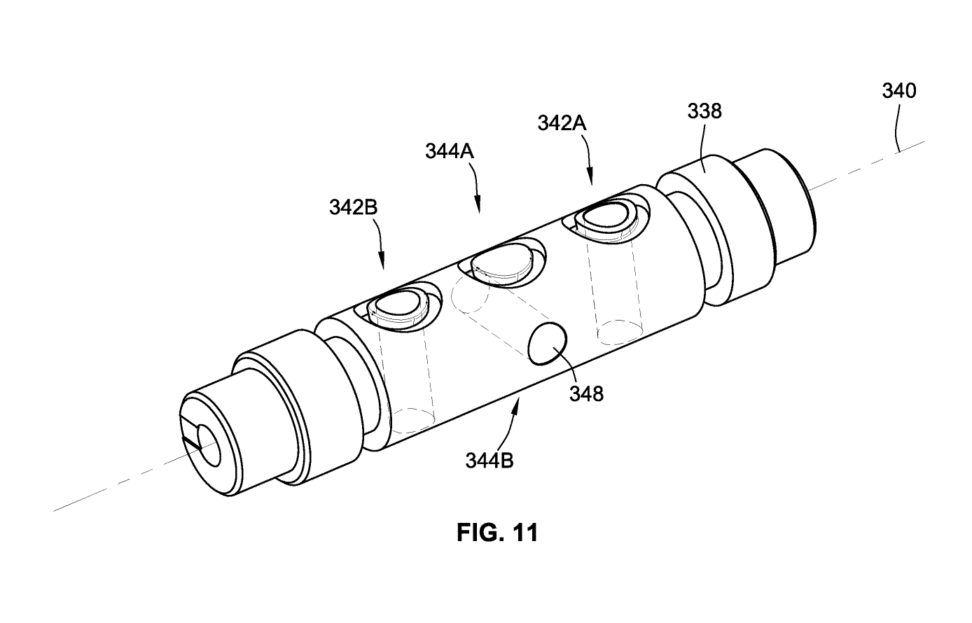

In this embodiment, the other interfaces between the valve body 114 and sleeve member 126 adjacent inlet and outlet ports do not need to have seal members as sufficient sealing is provided between the interface between the outer surface of the sleeve member 126 and the inner surface of the valve body 114. Further, there is no risk of back flow to the source of material for these interfaces such that the source of material would be contaminated. However, an alternative embodiment is disclosed in FIGS. 9-10 that provides seals for each interface and is described in more detail below.

For the same reason, the other interfaces between the sleeve member 126 and valve member 138 proximate the other inlet and outlet ports 130, 132, 134 of the sleeve member do not need seal members.

The sleeve member 126 is made from a material that provides low shear as a result of the motion of the valve member 138 within the sleeve member 126. As noted above, highly filled shear sensitive materials should be processed in low shear environments to avoid exposing the material to high energy levels created by shear to prevent thickening, gelling or curing of the material due to the processing equipment.

In one embodiment, the sleeve member 126 is formed from a low shear material while the valve body 114 and valve member 138 are formed from metal such as aluminum or stainless steel and preferably hardened steel. More particularly, in an embodiment, the sleeve member 126 is formed from, for example, ultra-high molecular weight polyethylene (UHMWPE), polytetrafluoroethylene (PTFE) such as TEFLON®; polyoxymethylene (POM) such as DELRIN®; polytetrafluoroethylene filled DELRIN® etc. These materials have a low coefficient of friction as well are self-lubricating and highly resistant to abrasion. As such, it provides low shear (e.g. having a coefficient of friction of less than 0.5) and also can stand up to the abrasion provided by the highly filled materials.

Highly filled materials often have suspensions of glass beads, glass fibers, carbon fibers, quartz, silica, and other materials. The particulate size of filled materials can range from the nano scale to particles that are on scale of the tenths of millimeters. The particulates cause premature wear on regular surfaces, and will often ruin materials such as PTFE or POM coated pin or bore. The replaceable sleeve member 126 and metal valve member 138 increases the life of the valve and allow for lower maintenance costs. For instance, the replaceable sleeve member 126 would be a lower cost repair item than replacing an entire valve.

Further, as noted above, the sleeve member 126 can be easily replaced in the event that it has worn. This is a benefit of having the sleeve member 126 be a separate standalone component as compared to simply providing a coating on either the valve member 138 or the inner surface of the valve body 114.

With reference to FIGS. 9-10, an alternative embodiment of a sleeve member 226 and valve member 238 is illustrated. In this embodiment, all of the inlet and outlet ports 228, 230, 232, 234 of the sleeve member 226 have seals 276A-276D (e.g. o-rings) located in grooves formed in an outer surface of the sleeve member 226. These seals 276A-276D are used to seal the respective ports with the inlet and outlet ports of the valve body 114 described previously.

Further, the valve member 238 has seals 277A-B and 278A-B mounted in grooves in the outer surface thereof. Seals 2771-B surround first and second shut-off regions 244A-B to prevent fluid back flow when fluid is dispensed out of the valve body 114.

This embodiment illustrates that additional sealing can be provided between the valve body 114, sleeve member 226 and valve member 238.

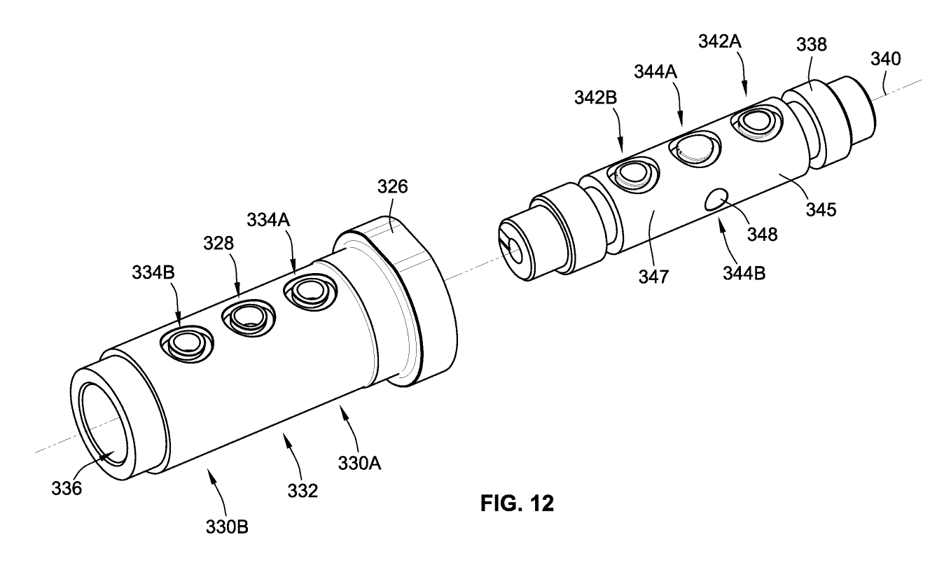

FIGS. 12 and 13 illustrate a further embodiment of a sleeve member 326 and valve member 338. In this embodiment, the resulting valve would have more than 2 ports, e.g. multiple inlet ports or multiple outlet ports. For example, the valve could have a single input but provide dual outputs to supply material to multiple molds upon a single actuation of a pump assembly.

For example, the sleeve member 326 could have first, second and third inlet ports 328, 330A, 330B and first, second and third outlet ports 332, 334A, 334B. The ports of the sleeve member 326 would communicate with ports of a valve body similar to the prior embodiments, except there would be more ports in the valve body.

The valve member 338 is slidably and rotatably carried within the sleeve member internal cavity 336. The valve member 338 in this embodiment is rotatable between a first position that prevents fluid flow from the first sleeve member inlet port 328 to the first sleeve member outlet port 332 but permits fluid flow from the second and third sleeve member inlet ports 330A, 330B to the second and third sleeve member outlet ports 334A, 334B, respectively. More particularly, in this position, first and second flow passages 342A, 342B that extend transversely to axis 340 through the valve member 338 fluidly connect the second sleeve member inlet ports 330A, 330B to the second sleeve member outlet ports 334A, 334B.

The valve member 338 includes first and second shut-off regions 344A, 344B that aligns with the first sleeve member inlet port 328 and first sleeve member outlet port 332 to prevent fluid flow therebetween.

In a second position, the valve member 338 is rotated 90 degrees and the first sleeve member inlet port 328 is fluidly connected to the first sleeve member outlet port 332 via third flow passage 348. Additionally, in this position, second shut-off regions 345, 347 prevent fluid flow from the second and third sleeve member inlet ports 230A, 230B to the second and third sleeve member outlet ports 334A, 334B, respectively.

In other embodiments, the inlet and outlet ports could be reversed such that two separate material sources are connected to the valve body. The two separate materials would flow through the valve member in the first position and mix. After mixing, the materials would be dispensed when the valve member is rotated to the first position.

Further, even further embodiments could have more flow ports for receiving more materials and/or dispensing material to more downstream systems, e.g. molds.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A valve assembly comprising:
a valve body defining a valve body internal cavity, a first valve body inlet port in communication with the internal cavity and a first valve body outlet port in fluid communication with the valve body internal cavity;
a low shear sleeve member positioned within the internal cavity, the sleeve member defining a sleeve member internal cavity, a first sleeve member inlet port in fluid communication with the sleeve member internal cavity and a first sleeve member outlet port in fluid communication with the sleeve member internal cavity, the first sleeve member inlet port is in fluid communication with the first valve body inlet port, the first sleeve member outlet port is in fluid communication with the first valve body outlet port; and
a valve member slidably carried within the sleeve member internal cavity, the valve member including a first flow passage formed within the valve member and a first shut-off region formed by the valve member, the valve member being moveable between a first position in which fluid flow from the first sleeve member inlet port to the first sleeve member outlet port is prohibited and a second position in which fluid flow from the first sleeve member inlet port to the first sleeve member outlet port is permitted.

2. The valve assembly of claim 1, wherein an inner surface of sleeve member defining the sleeve member internal cavity and an outer surface of the valve member define a sliding interface; wherein the frictional coefficient between the inner surface and the outer surface is greater than 0.0 and less than or equal to 0.5.

3. The valve assembly of claim 1, wherein the valve member is rotatably carried within the sleeve member.

4. The valve assembly of claim 1, wherein the sleeve member is replaceable.

5. The valve assembly of claim 1, wherein the valve member is formed from metal, the valve body is formed from metal and the sleeve member is formed from a low friction non-metal.

6. The valve assembly of claim 5, wherein the low friction non-metal is an ultra-high molecular weight polyethylene.

7. The valve assembly of claim 1, wherein the sleeve member is fixed relative to the valve body to prevent motion of the sleeve member when the valve member moves between the first and second positions.

8. The valve assembly of claim 1, wherein the valve member carries a first seal member that surrounds the first shut-off region and seals on an inner surface of the sleeve member and around the first sleeve member inlet port when the valve member is in the first position.

9. The valve assembly of claim 8, further comprising a second seal member that seals the first valve body inlet port to the first sleeve member inlet port.

10. The valve assembly of claim 9, wherein an interface between the sleeve member and the valve body at the first sleeve member and first valve body outlet ports is free of a seal member therebetween and interfaces between the sleeve member and the valve member in both the first and second positions is free of a seal member therebetween.

11. The valve assembly of claim 1, wherein:
the valve body defines a second valve body inlet port in communication with the internal cavity and a second valve body outlet port in fluid communication with the valve body internal cavity;
the low shear sleeve defines a second sleeve member inlet port in fluid communication with the sleeve member internal cavity and a second sleeve member outlet port in fluid communication with the sleeve member internal cavity, the second sleeve member inlet port is in fluid communication with the second valve body inlet port, the second sleeve member outlet port is in fluid communication with the second valve body outlet port; and
the valve member defines a second flow passage formed within the valve member and a second shut-off region formed by the valve member,
wherein when the valve member is in the second position, fluid flow from the second sleeve member inlet port to the second sleeve member outlet port is prohibited; and
wherein when the valve member is in the first position, fluid flow from the second sleeve member inlet port to the second sleeve member outlet port is permitted.

12. The valve assembly of claim 11, wherein the first and second valve body inlet ports are on opposite sides of the valve member as one another and the first and second valve body outlet ports are on opposite sides of the valve member as one another;
wherein the first valve body inlet port is on the same side of the valve member as the second valve body outlet port.

13. The valve assembly of claim 1, wherein the valve member is operably coupled to an actuator for driving the valve member between the first and second positions.

14. A material delivery system comprising:
a valve assembly of claim 12;
a pumping body having a pumping body pumping cavity in fluid communication with the first valve body outlet and the second valve body inlet;
a pumping piston carried in the pumping body pumping cavity configured to increase and decrease the volume within the pumping body pumping cavity;
wherein fluid is permitted to flow into the pumping body pumping cavity through the first valve body outlet when the valve member is in the second position and permitted to flow out of the pumping body pumping cavity through the second valve body inlet when the valve member is in the first position.

15. The material delivery system of claim 14, wherein:
the valve member is operably coupled to an actuator for driving the valve member between the first and second positions; and
the pumping piston is operably coupled to an actuator for driving the pumping piston.
